(19) United States
(12) Patent Application Publication
(10) Pub. No.: US 2017/0199969 A1
(43) Pub. Date: Jul. 13, 2017

(54) SYSTEM AND METHOD FOR MONITORING GROSS MOTOR BEHAVIOR

(71) Applicant: The Joan and Irwin Jacobs Technion-Cornell Innovation Institute, New York, NY (US)

(72) Inventors: Yaron LEVINSON, Kfar Saba (IL); Tsvi TSADOK, Tel Aviv (IL)

(73) Assignee: The Joan and Irwin Jacobs Technion-Cornell Innovation Institute, New York, NY (US)

(21) Appl. No.: 14/992,518

(22) Filed: Jan. 11, 2016

(51) Int. Cl. G06F 19/00; G06N 5/04; G06N 99/00

(52) U.S. Cl. CPC G06F 19/345; G06N 99/005; G06N 5/047

(57) ABSTRACT

A system and method for assessing gross motor functions based on user input patterns are provided. The method includes receiving raw data related to at least a movement of a user; computing, based on the raw data, at least one step feature; generating a session pattern based on the at least one step feature; and generating, using the session pattern and a decision model, a scale index indicating a current condition of the gross motor functionality of the raw data.

### TECHNICAL FIELD

The present disclosure relates generally to motoric behavior, and more specifically to assessing gross motor functions of users based on motion analysis.

### BACKGROUND

Neuromuscular and musculoskeletal disorders affect the nerves that control voluntary muscles such as, e.g., arm and leg muscles. Individuals experiencing neuromuscular disorders exhibit decreased communication between the nervous system and muscles, thereby leading to weakened muscles. Consequently, such individuals experience symptoms such as tremor, bradykinesia, rigidity of muscles, twitching, cramps, aches and pains, and joint and movement problems. Proper diagnosis of neuromuscular disorders is crucial to securing appropriate treatment and improving the outcome of the treatment.

Conventional means of testing for neuromuscular disorders include electromyography (EMG), which involves inserting a needle electrode directly into a muscle to determine electrical activity in the muscle. This electrical activity can be compared and interpreted in order to diagnose neurological and muscular disorders. Although a low-risk procedure, EMG presents risks of bleeding, infection, and nerve injury around the point of needle insertion. As a result, EMG diagnosis may be impracticable for individuals who have had an electrical medical device (e.g., a pacemaker) implanted and/or have hemophilia. Additionally, the procedure for diagnosing neurological disorders via EMG may be painful or otherwise inconvenient for patients.

Notably, some neuromuscular conditions manifest as deviations from typical gross motor skills. Gross motor skills are related to movements of larger muscle groups such as those in the arms and legs, as well as other larger body part movements. Exemplary gross motor skills include head control, standing up, walking, running, climbing, and jumping. Existing solutions for evaluating gross motor function include measuring gait and walking speed. In particular, the six-minute walk test measures how far an individual is able to walk on a hard, flat surface in 6 minutes. Another test, the timed 25-foot walk, involves measuring the time in which an individual takes to walk 25 feet in a straight line. Patients being evaluated for neuromuscular conditions typically perform these tests in a clinical setting using a treadmill or a set course.

The disadvantages of current procedures for evaluating neuromuscular disorders are that they require the user to visit the clinics from time to time to assess only the current conditions of disease. As such, the user's conditions are not monitored on a daily basis. Consequently, such procedures cannot proactively predict any improvement or deterioration of the user's condition. In addition, as standardized tests are limited, their results cannot be analyzed to derive more accurate scales. Further, complex and prolonged tests cannot be performed during clinical visits.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

The disclosed embodiments include a method for assessing gross motor functions based on user input patterns. The method comprises: receiving raw data related to at least a movement of a user; computing, based on the raw data, at least one step feature; generating a session pattern based on the at least one step feature; and generating, using the session pattern and a decision model, a scale index indicating a current condition of the gross motor functionality of the raw data.

The disclosed embodiments also include a system for assessing gross motor functions based on user input patterns. The system comprises: a processing unit; and a memory, the memory containing instructions that, when executed by the processing unit, configure the system to: receive raw data related to at least a movement of a user; compute, based on the raw data, at least one step feature; generate a session pattern based on the at least one step feature; and generate, using the session pattern and a decision model, a scale index indicating a current condition of the gross motor functionality of the raw data.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of a network system utilized to describe the various disclosed embodiments.

FIG. 2 is a diagram illustrating an operation of a decision model according to an embodiment.

FIG. 3 is a decision model implemented using a regression tree according to an embodiment.

FIG. 4 is a flowchart illustrating a method for determining an index scale for gross motor functions according to an embodiment.

FIG. 5 is a flowchart illustrating a method for providing step features according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

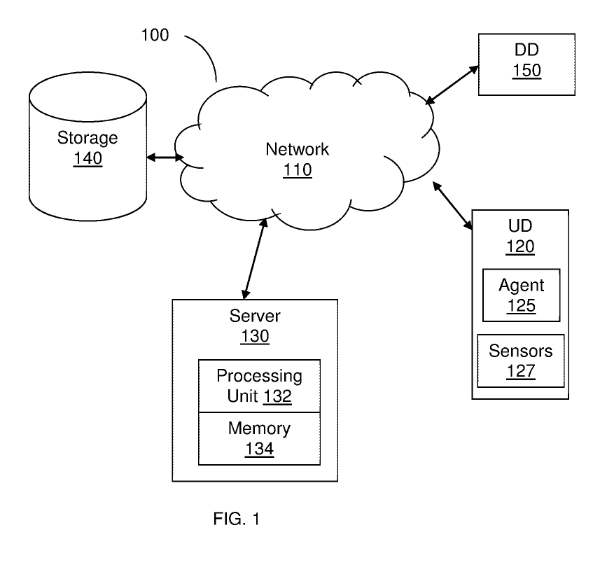

FIG. 1 shows an exemplary and non-limiting network diagram 100 utilized to describe the various disclosed embodiments. The network diagram 100 includes a network 110, a user device 120, a server 130, a storage 140, and a diagnostic device 150. The server 130, the user device 120, and the storage 140 may be connected via the network 110. The network 110 may be, but is not limited to, a wireless, cellular, or wired network; a local area network (LAN); a wide area network (WAN); a metro area network (MAN); the Internet; the worldwide web (WWW); similar networks; and any combination thereof.

The user device 120 is configured to execute at least one agent 125. The agent 125 may be, for example, a web browser, a script, an add-on, a mobile application (“app”), or any type of software application. The user device 120 also includes a plurality of sensors 127 that may include, but are not limited to, accelerometers, gyroscopes, motion sensors, and the like. In an embodiment, the user device 120 may include a handheld device, such as a mobile phone, a smart phone, a tablet computer, a wearable computing device, and the like.

In an embodiment, the diagnostic device (DD) 150 is utilized to interact with the server 130 to at least review results of the analysis. The results (scales) may be related to a user or group of users, a disease area, and so on. The diagnostic device 150 may be operated by a physician, a clinician, a caregiver, a researcher (e.g., of a pharmaceutical company), and so on. In an embodiment, the diagnostic device 150 may be, but is not limited to, a PC, a PDA, a mobile phone, a smart phone, a tablet computer, a laptop, and the like.

According to the disclosed embodiments, the agent 125 is configured to collect raw data related to movements of a user holding or wearing the user device 120. The collected raw data may include sensor signals such as, but not limited to, angular rotational velocity measurement, linear acceleration of movement, orientation of the user device 120, and so on. The raw data can be gathered from an operating system of the user device, from a co-processor, and/or through various processes performed by the agent 125. The raw data may be collected via an operating system (not shown) of the user device 120 based on signals detected by the sensors 127 and/or via a co-processor (not shown). In an embodiment, the raw data is collected per session (e.g., at a preconfigured time interval) or continuously as the user moves. A co-processor is a processing unit integrated in an advanced computing device and designed to perform the tasks of analyzing movements (e.g., walking, running, jumping, etc.) of a user.

The collected raw data is sent to the server 130 for further processing and may be stored in the storage 140. In an embodiment, only raw data that can be used for accurate calculation or estimation of motion attributes is sent to the server 130. In another embodiment, the entire collected raw data is sent to the server 130. The raw data is filtered by the server 130 such that only data that can used for accurate calculation or estimation of motion attributes is extracted. As the motion attributes are based on, at least, a medical diagnosis, the source (collected raw data) should identify a stable motion state during a spontaneous walk of the user. The stable motion state, in an embodiment, is a user walking on a flat surface during a predefined time interval. Identification of the stable motion state is performed based on processing of the raw data to determine if the data meets certain predefined stability thresholds. In a non-limiting embodiment, the collected raw data includes sensory signals of an accelerometer and gyroscope. In a further embodiment, the stability thresholds may be set to determine whether the frequency, amplitude, and a noise to signal ratio of each detected signal meets a respective stability threshold. In another embodiment, the accelerometer and gyroscope signals can be correlated with other signals (such as, but not limited to, Wi-Fi inputs, co-processor inputs, GPS signals, etc.) to increase the likelihood for detection of a stable motion state.

The collected raw data may be provided with the server 130 or stored together with the identity of the user device 120. For example, a user name, a full name, and/or identification information may be stored as an identity. In another embodiment, the server 130 can also receive clinical background data related to a user or a group of users to perform the analysis. Such clinical background data can be provided by the user device 120, by the diagnostic device 150, or retrieved from the storage 140.

According to various embodiments, the agent 125 may attempt to send the collected raw data to the server 130 upon conclusion of a session, at a regular time interval (e.g., every hour), when a sufficient amount of data is collected, and so on. In an embodiment, if the agent 125 cannot send the collected raw data to the server 130 (e.g., if there is no connection between the user device 120 and the server 130), the agent 125 may store the collected raw data locally on the user device 120. In a further embodiment, the agent 125 may continue to attempt to send the previously collected raw data to the server 130 at a later time and/or periodically thereafter until the raw data is successfully sent.

According to the disclosed embodiments, the server 130 is configured to generate a baseline pattern for each user or a group of users using the collected raw data. The baseline pattern can be updated from time to time. The server 130 is configured to compute, based in part on a decision model, a scale index for determining the neuromuscular condition of a user. The scale index can be computed or generated as a new set of raw data is received. The scale index can be sent to or accessed by the diagnostic device 150 through a GUI or API. The scale index is computed with respect to at least one motion attribute. A motion attribute may be computed per session and may include, but is not limited to, speed, step timing, step size, sway, gait cadence, velocity, and so on.

The various embodiments performed by the server 130 will be now described in more detail. First, a set of features related to each pair of steps (hereinafter “step features”) detected during a stable motion state are extracted or otherwise computed based on the collected raw data. The step features may include, but are not limited to, speed, root-mean square, peak amplitude, mean crossing rate, and so on.

In an embodiment, based on the step features, a session pattern is generated. The session pattern is a collection of step feature measurements collected during a particular session. The baseline pattern is a set of session patterns collected during a predefined interval (e.g., a week, a month, and so on). Any of the session pattern or the baseline pattern may have a predefined format.

In an embodiment, the baseline pattern is utilized, in part, to train a decision model. The training can be also performed using multiple results gathered through “gold standard” tests, which benchmark tests based on a large sample size of users. The session patterns are input to the decision model based on the changes in between two or more session patterns and, relative to the training data set, a scale index for one or more motion attributes is generated. The scale index may be in a format compliant with one or more standardized scales. In an embodiment, the generated scale index is a non-standardized scale. In an exemplary embodiment, the non-standardized scale is a numerical number (e.g., 1-10) indicating the severity of neuromuscular conditions. Alternatively, or collectively, the scale index provides a ratio between the motion attribute measurements (represented in the session pattern) and a non-standardized scale. This scale index allows physicians to correlate the measurements to known “gold standard” tests. In an embodiment, the decision model is configured to output only the estimated value of the motion attribute. For example, the estimated walking speed of a user during a current session.

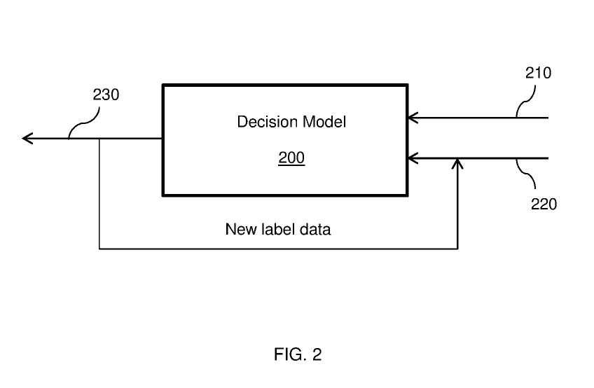

The decision model can be realized through, for example, a regression tree, a neural network (e.g., an artificial neural network), a support vector machine, and the like. An example for a decision model implemented according to an embodiment is described further herein below with respect to FIG. 2.

The server 130 typically includes a processing unit 132 coupled to a memory 134. The processing unit 132 may comprise or be a component of a processor (not shown) or an array of processors coupled to the memory 134. The memory 134 contains instructions that can be executed by the processing unit 132. The instructions, when executed by the processing unit 132, cause the processing unit 132 to perform the various functions described herein. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

It should be noted that one user device 120 and one server 130 are illustrated in FIG. 1 merely for the sake of simplicity and without limitation on the generality of any of the disclosed embodiments. It should be further noted that the embodiments disclosed herein are not limited to the specific architecture illustrated in FIG. 1, and other architectures may be equally used without departing from the scope of the disclosed embodiments. Specifically, the server 130 may reside in the cloud computing platform, a datacenter, and the like. Moreover, in an embodiment, there may be a plurality of servers 130 operating as described hereinabove and configured to either have one as a standby, to share the load between them, or to split the functions between them.

FIG. 2 shows an exemplary and non-limiting decision model 200 utilized according to an embodiment. The decision model 200 receives two inputs: a training data set 210 and session patterns 220. The decision model 200 outputs an index scale 230. As noted above, the index scale 230 may be a non-standardized scale or a standardized scale.

The collected training data set 210 includes a set of movement patterns of various users or a specific user, labeled according to one or more gold standard scales. In an embodiment, the collected training set 210 may be based on sensor signals detected during calibration sessions. The calibration sessions may include, but are not limited to, walking on a treadmill for a predetermined period of time at varying speeds, walking a predefined distance at varying speeds, and/or walking a predefined distance for a predefined period of time. The calibration sessions may be repeated from time to time, for example, each time that a user visits at a clinic.

Label data refers to a validated or verified scales that can be associated with movement patterns. The label data may be provided, for example, by a physician, a clinician, a caregiver, a researcher, and the like. The label data may associate a specific scale with any movement pattern based on the gold standard tests. The physician can diagnose a patient using one or more of the gold standard tests. The gold standard may be based on, for example, the 6-Minutes-Walking-Test or the Timed 25 feet Walking Test.

Based on the diagnosis results, a standardized scale is provided. The movement patterns of a patient can be assigned with the provided standardized scale which is the label data. The purpose of the model is using the training data set (which includes the label data) to predict the index scale 230 of the user based on the session patterns 220.

In an embodiment, new label data may be input to accompany the index scale 230 (e.g., data obtained when the user was examined in a clinic) to act as a feedback to the training set input 210 to improve the accuracy of the model. The decision model 200 is personalized to a specific user by being adapted based on training data captured from this specific user. As noted above, the decision model 200 may be implemented as, for example, a regression tree, a neural network (e.g., an artificial neural network), a support vector machine, and the like.

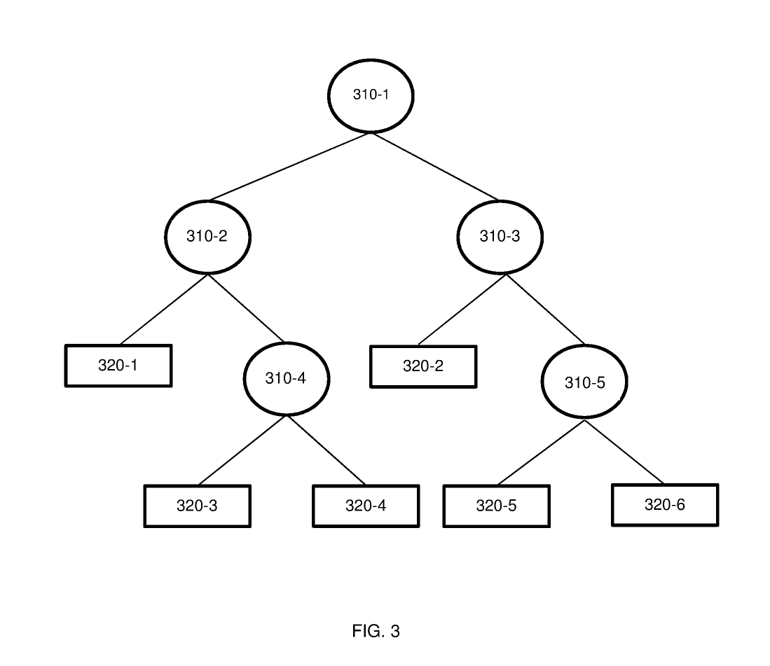

FIG. 3 shows an exemplary and non-limiting decision model implemented using a regression tree 300 according to an embodiment. Each node 310 in the tree 300 is configured to compare an established value “V” to a session value “u”. The established value may be a measurement of a motion attribute derived from the training data set, while the session value is a respective measurement from a particular session. For example, V₁ and u₁ of the node 310-1 may be root-mean-square acceleration measurements. The comparison made at each node 310 may be any one of: greater than, less than, equal to, not equal to, identical, and the like. The comparison may be performed on numerical values, Boolean values, strings, and so on.

Each of the leaves 320 of the tree 300 represents the index scale (such as, e.g., the index scale 230). That is, in order determine the index scale, the tree 300 is traversed from a root node 310-1 through the other nodes 310 until reaching a leaf 320. For example, the pairs of values <V1, u1>; <V2, u2>; and <V4, u4> are step features, e.g., measurements of root-mean-square, peak value, mean value, respectively, compared in the nodes 310-1, 310-2, and 320-4, respectively.

If the comparisons made in nodes 310-1 and 310-2 show that the established value V1 is greater than the session value u1, that the established value V2 is less than the session value u2, and that the established value V4 is greater than the than the session value u4, than the leaf 320-3 provides a scale index of 10. On the other hand, if the comparisons made in node 310-4 shows that the established value V4 is less than the session value u4, than the leaf 320-4 provides a scale index of 7. In this example, the scale index is determined based on a scale from 1 to 10. It should be noted that the exemplary tree 300 includes only a few nodes 310 merely for the sake of simplicity and without limitation on the disclosed embodiments. It should be further noted that the tree can be utilized to estimate the value of one or more motion attributes. That is, the leaves will indicate an estimated value of a motion attribute (e.g. speed, sway, and the like).

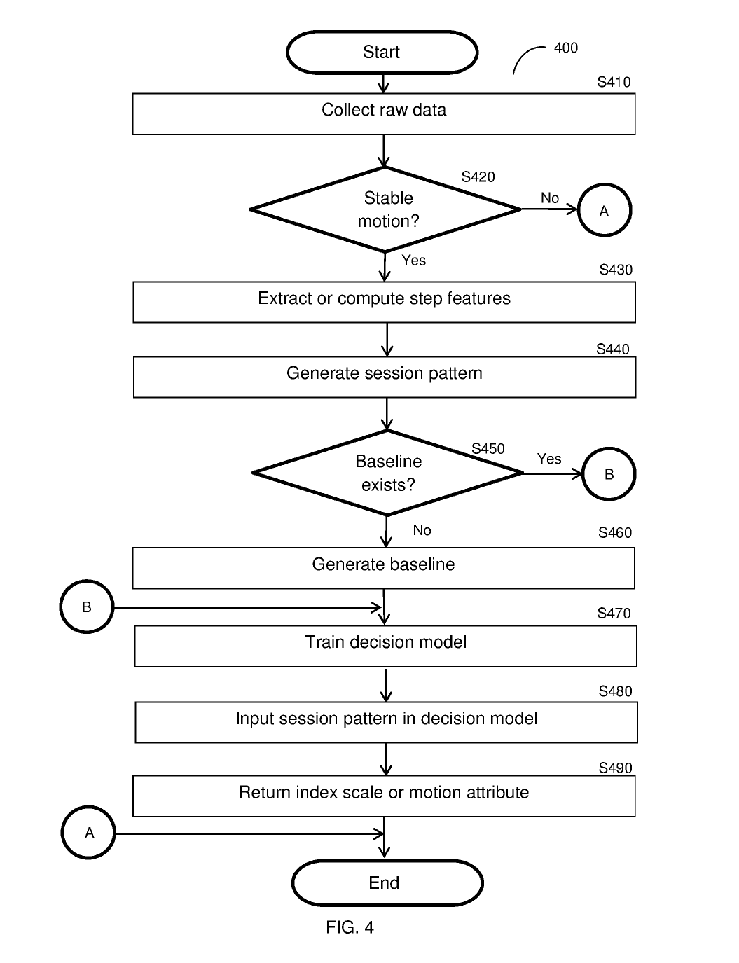

FIG. 4 is an exemplary and non-limiting flowchart 400 illustrating a method for determining an index scale and motion attributes for gross motor functions according to an embodiment. In S410, raw data related to user inputs of a user is received. In an embodiment, the raw data may be received from a coprocessor (e.g., a motion coprocessor, an operating system of a user device, and the like). In an embodiment, the raw data is collected per session (e.g., at a preconfigured time interval). The raw data may include sensory signals such as, but not limited to, angular rotational velocity measurement, linear acceleration of movement, and the orientation of the user device as detected via accelerometers, gyroscopes, motion sensors, and so on. The raw data may further include GPS signals, Wi-Fi signals, or any other type signal that can determine a location of a user.

In S420, the collected raw data is processed to determine whether a stable motion state is identified during a spontaneous walk of the user and, if so, execution continues with S430; otherwise, execution terminates. As noted above, in an embodiment, the stable motion state is a user walking on a flat surface during a predefined time interval. Identification of the stable motion state is performed based on processing of the raw data to determine if such data meets a certain predefined stability threshold. In a non-limiting embodiment, the collected raw data includes sensory signals of an accelerometer and gyroscope. In a further embodiment, the stability thresholds may be set to determine whether the frequency, amplitude, and a noise to signal ratio of each detect signal meet respective stability thresholds. In another embodiment, the accelerometer and gyroscope signals can be correlated with other signals (such as, Wi-Fi inputs, co-processor inputs, GPS signals, etc.) to increase the likelihood for detection of a stable motion state.

If a stable motion state is detected, execution continues with S430; otherwise, execution terminates. It should be noted that in certain embodiments, S420 can be performed prior to sending the raw data.

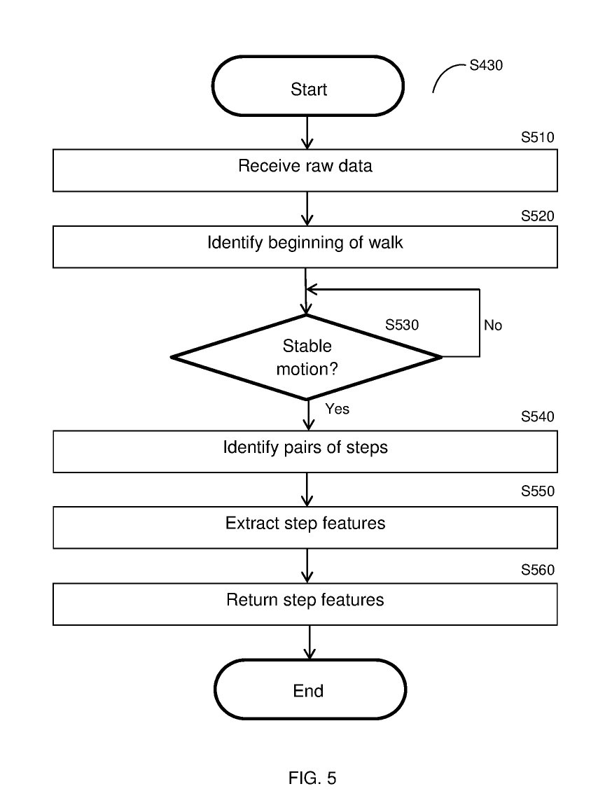

In S430, step features are extracted or computed based on the collected raw data. The step features are provided for each pair of steps identified during a stable motion state. The step features include at least measurements of root-mean-square, peak value, and/or mean value of each motion sensor as provided in the raw data. One embodiment for performing S430 is described further herein below with respect to FIG. 5.

In S440, a session pattern is generated based on the step features. The session pattern is a collection of root-mean-square, peak value, and/or mean value measurements collected during a particular session. The session pattern may have a predefined format.

In S450, it is checked whether a baseline pattern for the user exists. If so, execution continues with S470; otherwise, execution continues with S460. In S460, a baseline pattern is generated for the user. The baseline pattern is a set of session patterns collected during a predefined interval (e.g., a week, a month, etc.). The baseline pattern may have a predefined format. In S470, a decision model is trained based on the session pattern. It should be noted that the decision model may be “pre-trained” with data gathered during one or more calibration sessions. Examples for calibration sessions are provided below.

In S480, the session patterns are input to the trained decision model. The decision model includes a scale index for determining the neuromuscular or musculoskeletal condition of a user. The scale index can be computed or generated as a new set of session patterns is input. The decision model can be realized through, for example, a regression tree, a neural network (e.g., an artificial neural network), a support vector machine, and the like.

In an embodiment, upon detection of a change between the generated session pattern and at least one previous session pattern, the generated session pattern is input into the decision model. Relative to the training set and the generated session pattern, a scale index is generated and output by the decision model. The scale index may be in a format compliant with one or more standardized scales. In an embodiment, the generated scale index is a non-standardized scale. In an exemplary embodiment, the non-standardized scale is a numerical number (e.g., 1-10) indicating the severity of neuromuscular and/or musculoskeletal conditions. Alternatively or collectively, the scale index provides a ratio between the motion attribute measurements (represented in the session pattern) and a non-standardized scale. This scale index allows physicians to correlate the measurements to known “gold standard” tests.

In another embodiment, the decision model can be configured and trained to provide the estimated values of the motion attributes. An input session pattern (step features) can be mapped to a motion attribute such as speed, step timing, step size, sway, gait cadence, or velocity. In another embodiment, the estimated values for a specific motion attribute can be averaged over a few sessions.

In S490, the scale index and/or an estimated motion attribute that was output by the decision model is returned.

In an embodiment, new label data may be introduced to act as additional feedback to the training set input to improve the accuracy of the decision model. The new label data is related to a specific user that the model is programmed for. The new label data may be received, for example, when the user is diagnosed by a physician. The scale provided by the physician respective of the diagnosis is the new data set.

FIG. 5 is an exemplary and non-limiting flowchart S430 illustrating a process for providing step features according to an embodiment. In S510, raw data related to movement of a user of a user device is received. In an embodiment, the raw data may include sensor signals from sensors such as, but not limited to, accelerometers, global positioning system (GPS), gyroscopes, and so on. In another embodiment, the raw data may further include information regarding availability of Wi-Fi signals and/or cellular towers respective of the user device. In an embodiment, the method may begin upon receiving a request for checking gross motor behavior of the user.

In S520, based on the raw data, the beginning of a user walking is identified. The walking identified may be based on one or more predefined rules. For example, if the GPS location of the user changes over time, user walking may be identified. Whether a GPS location changes may be based on, for example, a predetermined threshold. As another example, if the user is currently switching between different Wi-Fi networks very rapidly, it may be determined that the user is in a moving vehicle, thus walking would not be identified at that time.

In S530, upon identifying the beginning of a walk, it is determined whether the user is in a stable motion state. If so, execution continues with S540; otherwise, execution waits at S530 until a stable motion state is detected. It should be noted that the wait may be timed-out, i.e., that the wait may cease after a predefined period of time has passed.

In S550, a pair of each steps taken by the user are identified in the raw data. In an embodiment, the identification of steps may be based on accelerometer and/or gyroscopes signals as well as known average of a step size or a step timing. The steps may be identified over a session having a predetermined period of time. In S540, step features are extracted from the raw data for each pair of steps. As noted above, the step features may include root-mean square, peak amplitude, mean crossing rate, and so on.

In S560, the step features are returned.

As a non-limiting example, raw data including accelerometer and GPS signals of a user device are received. The accelerometer signals indicate that the user device is moving and the GPS signals indicate that the position of the user device is changing because the difference between GPS signals taken at different times is above a predefined threshold of 100 feet. Based on the signals, it is determined that the user is walking in a stable manner. Steps taken by the user are identified based on the accelerometer signals. A timing for each pair of steps is determined for each pair of the identified steps. An estimated speed of 3 miles per hour is computed as an average of the step timings.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for assessing gross motor functions based on user input patterns, comprising:
receiving raw data related to at least a movement of a user;
computing, based on the raw data, at least one step feature;
generating a session pattern based on the at least one step feature; and
generating, using the session pattern and a decision model, a scale index indicating a current condition of the gross motor functionality of the raw data.

2. The method of claim 1, further comprising:
training the decision model based on a data set including at least any of: a collection of step features of a group of users, and label data associated with the collection of step features.

3. The method of claim 1, further comprising:
receiving new label data at predetermined intervals; and
feed-backing the decision model using the new label data.

4. The method of claim 1, wherein the raw data includes at least one of: an angular rotational velocity measurement, a linear acceleration of movement, and an orientation of a user device.

5. The method of claim 1, wherein the scale index is in a format compliant with at least one standardized scale.

6. The method of claim 1, wherein the decision model is any of: a regression tree, a decision tree, a neural network, and a support vector machine.

7. The method of claim 1, wherein the step features include at least one of: speed, root-mean square, peak amplitude, and mean crossing rate.

8. The method of claim 1, further comprising:
estimating, using the session pattern and the decision model, at least one motion attribute.

9. The method of claim 8, wherein the at least one motion attribute includes any one of: step timing, step size, sway, gait cadence, and velocity.

10. A non-transitory computer readable medium having stored thereon instructions for causing one or more processing units to execute the method according to claim 1.

11. A system for assessing gross motor functions based on user input patterns, comprising:
a processing unit; and
a memory, the memory containing instructions that, when executed by the processing unit, configure the system to:
receive raw data related to at least a movement of a user;
compute, based on the raw data, at least one step feature;
generate a session pattern based on the at least one step feature; and
generate, using the session pattern and a decision model, a scale index indicating a current condition of the gross motor functionality of the raw data.

12. The system of claim 11, wherein the system is further configured to:
train the decision model based on a data set including at least any of: a collection of step features of a group of users, and label data associated with the collection of step features.

13. The system of claim 11, wherein the system is further configured to:
receive new label data at predetermined intervals; and
feed-back the decision model using the new label data.

14. The system of claim 11, wherein the raw data includes at least one of: an angular rotational velocity measurement, a linear acceleration of movement, and an orientation of a user device.

15. The system of claim 11, wherein the scale index is in a format compliant with at least one standardized scale.

16. The system of claim 11, wherein the decision model is any of: a regression tree, a decision tree, a neural network, and a support vector machine.

17. The system of claim 11, wherein the step features include at least one of: speed, root-mean square, peak amplitude, and mean crossing rate.

18. The system of claim 11, wherein the system is further configured to:
estimate, using the session pattern and the decision model, at least one motion attribute.

19. The system of claim 18, wherein the at least one motion attribute includes any one of: step timing, step size, sway, gait cadence, and velocity.

20. The system of claim 11, wherein the raw data is received from a user device of the user, wherein the user device is a handheld device.
